(19) United States
(12) Patent Application Publication
(10) Pub. No.: US 2009/0133065 A1
(43) Pub. Date: May 21, 2009

(54) Information accumulation apparatus, information display method and computer program

(75) Inventors: Kenichi Inoue, Kanagawa (JP); Hiroshi Hane, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/291,235

(22) Filed: Nov. 6, 2008

(30) Foreign Application Priority Data
Nov. 15, 2007 (JP) P2007-297124

(51) Int. Cl. G06F 3/00

(52) U.S. Cl. 725/40

(57) ABSTRACT

There is provided an information accumulation apparatus that accumulates contents and has a power-on state and a standby state as a power state, which includes an information collection portion to collect information including content information related to a content and internal information related to the information accumulation apparatus during the power-on state, an information acquisition portion to acquire the information collected by the information collection portion during transition from the power-on state to the standby state, and a display portion to sequentially display the information acquired by the information acquisition portion during the standby state.

### CROSS-REFERENCE TO RELATED APPLICATION

The present invention contains subject matter related to Japanese Patent Application JP 2007-297124 filed in the Japan Patent Office on Nov. 15, 2007, the entire contents of which being incorporated herein by reference.

### BACKGROUND OF THE INVENTION

1. Field of the Invention

The present invention relates to an information accumulation apparatus, an information display method and a computer program.

2. Description of the Related Art

In recording and playback devices that record and play back programs, media to record programs shift from video tapes to disk media such as high-capacity hard disks and optical disks. Because the high-capacity hard disks and optical disks are capable of recording programs for several tens to several hundreds of hours, it is possible to record or erase programs (contents) easily and conveniently. Accordingly, the number of programs (contents) that can be recorded becomes enormous, and devices capable of handling supplementary information for managing programs (contents) become numerous. Examples of supplementary information for managing programs (contents) are electronic program guide (EPG) information, title information and so on.

A recording and playback device that automatically records a program with the use of supplementary information for managing programs (contents) has been developed. In such a recording and playback device, if a user inputs the genre of a content, the name of an entertainer to appear or the like as a keyword, and the input keyword is contained in EPG information, the device can record the content. Therefore, the contents recorded in such a recording and playback device include contents that are not recognized by a user.

A technique to notify a user of information about enormous viewable contents is disclosed in Japanese Unexamined Patent Application Publication No. 2002-320161, for example. Japanese Unexamined Patent Application Publication No. 2002-320161 discloses a technique that extracts program information and displays the extracted program information on a part of a television screen.

### SUMMARY OF THE INVENTION

However, because the technique of Japanese Unexamined Patent Application Publication No. 2002-320161 displays program information on a television screen, it is necessary to turn on the television in order to view the program information. In other words, it is necessary to turn on a display device for displaying a content in order to notify a user of information about the content, and therefore a user cannot efficiently view information about the content.

In light of the foregoing, it is desirable to provide a novel and improved information accumulation apparatus, an information display method and a computer program capable of effectively notifying a user of information about recorded contents or contents to be recorded, information about the state of the apparatus and so on.

According to an embodiment of the present invention, there is provided an information accumulation apparatus that accumulates contents and has a power-on state and a standby state as a power state, which includes an information collection portion to collect information including content information related to a content and internal information related to the information accumulation apparatus during the power-on state, an information acquisition portion to acquire the information collected by the information collection portion during transition from the power-on state to the standby state, and a display portion to sequentially display the information acquired by the information acquisition portion during the standby state.

In this configuration, the information collection portion collects information that includes content information related to a content and internal information related to the information accumulation apparatus when the information accumulation apparatus is in the power-on state, the information acquisition portion acquires the information that is collected by the information collection portion while the state of the information accumulation apparatus makes transition from the power-on state to the standby state, and the display portion sequentially displays the information that is acquired by the information acquisition portion when the information accumulation apparatus is in the standby state. By displaying the information on the display portion that is included in the information accumulation apparatus, it is possible to effectively notify a user of information about recorded contents or contents to be recorded, information about the state of the apparatus and so on.

The information accumulation apparatus may further include an execution control portion to control execution of processing based on the information displayed on the display portion according to an operation command from a user by shifting the power state to the power-on state. In this configuration, the execution control portion shifts the power state to the power-on state and controls execution of processing based on the information that is displayed on the display portion according to an operation command from a user. Therefore, if a user inputs an operation command to the information accumulation apparatus by viewing the information displayed on the display portion, the information accumulation apparatus can directly execute processing corresponding to the information.

The information collection portion may collect content information of an accumulated content, the display portion may display the content information of the accumulated content, and the execution control portion may control execution of processing to prompt playback of the accumulated content according to an operation command from a user. In this configuration, it is possible to inform a user of the presence of contents that are automatically accumulated based on the preference of the user and the presence of contents that are accumulated because of recording reservation made by the user. Further, by executing the processing to prompt playback of the content upon receiving an operation command from a user when information about the accumulated content is displayed, it is possible to playback the content with a simple operation.

The information accumulation apparatus may further include a display setting portion to set a frequency to display and/or whether to display the information collected by the information collection portion on the display portion, and the information acquisition portion may acquire the information collected by the information collection portion based on setting of the display setting portion. In this configuration, the display setting portion sets a frequency to display and/or whether to display the information that is collected by the information collection portion on the display portion, and the information acquisition portion acquires the information that is collected by the information collection portion based on the setting of the display setting portion. It is thereby possible to increase the frequency to display information that is desired by a user, to reduce the frequency to display information that is not desired by a user, or not to display information.

The display setting portion may set a priority order of the information to be displayed on the display portion. Further, the information collection portion may collect advertisement information.

According to another embodiment of the present invention, there is provided an information accumulation apparatus that accumulates contents and has a power-on state and a standby state as a power state, which includes an information collection portion to collect information including content information related to a content and internal information related to the information accumulation apparatus during the power-on state, and an information transfer portion to transfer the information collected by the information collection portion to another device connected over a network so as to display the information on the other device during transition from the power-on state to the standby state.

In this configuration, the information collection portion collects information that includes content information related to a content and internal information related to the information accumulation apparatus when the information accumulation apparatus is in the power-on state, and the information transfer portion transfers the information that is collected by the information collection portion to another device connected over a network so that the information is displayed on the other device while the state of the information accumulation apparatus makes transition from the power-on state to the standby state. By transferring the collected information to another device that is connected to the information accumulation apparatus over a network so as to make the collected information displayed on the other device, it is possible to effectively notify a user of information about recorded contents or contents to be recorded, information about the state of the apparatus and so on.

The information accumulation apparatus may further include an execution control portion to control execution of processing based on the information transferred to the other device according to an operation command from a user by shifting the power state to the power-on state. In this configuration, the execution control portion shifts the power state to the power-on state and controls execution of processing based on the information transferred to the other device according to an operation command from a user. Therefore, if a user inputs an operation command to the information accumulation apparatus by viewing the information transferred to and displayed on the other device, such as a mobile terminal, the information accumulation apparatus can directly execute processing corresponding to the information.

The information collection portion may collect content information of an accumulated content, the display portion may display the content information of the accumulated content, and the execution control portion may control execution of processing to prompt playback of the accumulated content according to an operation command from a user. In this configuration, it is possible to inform a user of the presence of contents that are automatically accumulated based on the preference of the user and the presence of contents that are accumulated because of recording reservation made by the user. Further, by executing the processing to prompt playback of the content upon receiving an operation command from a user when information about the accumulated content is displayed, it is possible to playback the content with a simple operation.

The information accumulation apparatus may further include a transfer setting portion to set a frequency to transfer and/or whether to transfer the information collected by the information collection portion to the other device, and the information transfer portion may transfer the information collected by the information collection portion based on setting of the transfer setting portion.

The transfer setting portion may set a priority order of the information to be displayed on the other device. Further, the information collection portion may collect advertisement information.

According to another embodiment of the present invention, there is provided an information display method for displaying information on an electronic device that accumulates contents and has a power-on state and a standby state as a power state, which includes the steps of collecting information including content information related to a content and internal information related to the electronic device during the power-on state, acquiring the information collected in the collecting step during transition from the power-on state to the standby state, and sequentially displaying the information acquired in the acquiring step during the standby state.

According to another embodiment of the present invention, there is provided an information display method for displaying information on an electronic device that accumulates contents and has a power-on state and a standby state as a power state, which includes the steps of collecting information including content information related to a content and internal information related to the electronic device during the power-on state, and transferring the information collected in the collecting step to another device connected over a network so as to display the information on the other device during transition from the power-on state to the standby state.

According to another embodiment of the present invention, there is provided a computer program for displaying information on a computer that accumulates contents and has a power-on state and a standby state as a power state, causing the computer to execute a process including the steps of collecting information including content information related to a content and internal information related to the computer during the power-on state, acquiring the information collected in the collecting step during transition from the power-on state to the standby state, and sequentially displaying the information acquired in the acquiring step during the standby state.

According to another embodiment of the present invention, there is provided a computer program for displaying information on a computer that accumulates contents and has a power-on state and a standby state as a power state, causing the computer to execute a process including the steps of collecting information including content information related to a content and internal information related to the computer during the power-on state, and transferring the information collected in the collecting step to another device connected over a network so as to display the information on the other device during transition from the power-on state to the standby state.

According to the embodiments of the present invention described above, there are provided a novel and improved information accumulation apparatus, an information display method and a computer program capable of effectively notifying a user of information about recorded contents or contents to be recorded, information about the state of the apparatus and so on.

### BRIEF DESCRIPTION OF THE DRAWINGS

FIG. 1 is an explanatory view illustrating the appearance of a recording and playback device 10 according to a first embodiment of the present invention.

FIG. 2 is an explanatory view illustrating the appearance of a remote control 12 for operating the recording and playback device 10 according to the first embodiment of the present invention.

FIG. 3 is an explanatory view illustrating the configuration of the recording and playback device 10 according to the first embodiment of the present invention.

FIG. 4A is a flowchart illustrating the operation of the recording and playback device 10 according to the first embodiment of the present invention.

FIG. 4B is a flowchart illustrating the operation of the recording and playback device 10 according to the first embodiment of the present invention.

FIG. 5 is an explanatory view showing an example of the relationship between information selected by a main microcomputer 122 and management information in a table.

FIG. 6 is an explanatory view illustrating the case where program information of a program that is likely to be played back by a user is displayed on a display portion 114.

FIG. 7 is an explanatory view showing a playback confirmation window.

FIG. 8 is an explanatory view illustrating a recording and playback device 20 and a mobile terminal 200 according to a second embodiment of the present invention.

FIG. 9 is an explanatory view illustrating the hardware configuration of the mobile terminal 200 according to the second embodiment of the present invention.

FIG. 10A is a flowchart illustrating the operation of the recording and playback device 20 and the mobile terminal 200 according to the second embodiment of the present invention.

FIG. 10B is a flowchart illustrating the operation of the recording and playback device 20 and the mobile terminal 200 according to the second embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### First Embodiment

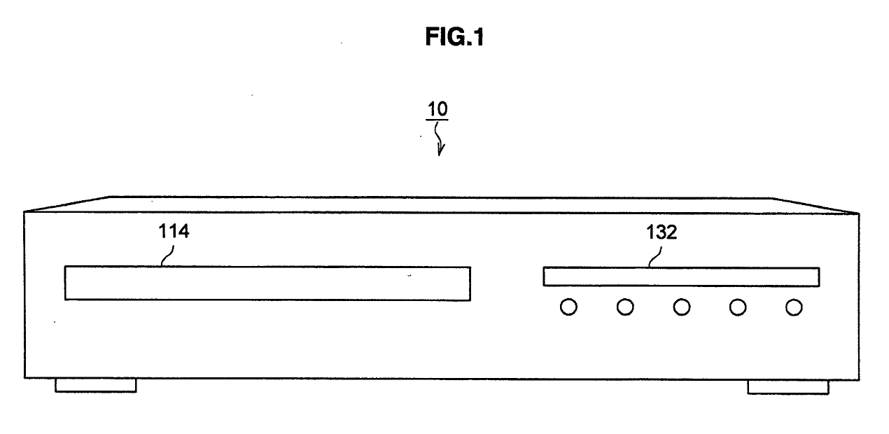

A recording and playback device, which is an example of the information accumulation apparatus of the present invention, according to a first embodiment of the present invention is described firstly. FIG. 1 is an explanatory view illustrating the appearance of a recording and playback device 10 according to the first embodiment of the present invention. The appearance of the recording and playback device 10 according to the first embodiment of the present invention is described hereinafter with reference to FIG. 1.

The recording and playback device 10 shown in FIG. 1 is an example of the information accumulation apparatus of the present invention, and it includes a hard disk drive for recording programs inside. The recording and playback device 10 further includes a drive 132 into which an optical disk for recording a program and playing back a video is loaded. The recording and playback device 10 also includes a display portion 114. The display portion 114 displays information such as the current time, a playback time and a recordable time of the hard disk or the optical disk. In this embodiment, the display portion 114 also displays a variety of information about the recording and playback device 10.

The appearance of the recording and playback device 10 according to the first embodiment of the present invention is described with reference to FIG. 1 in the foregoing. In the following, the appearance of a remote control for operating the recording and playback device 10 according to the first embodiment of the present invention is described.

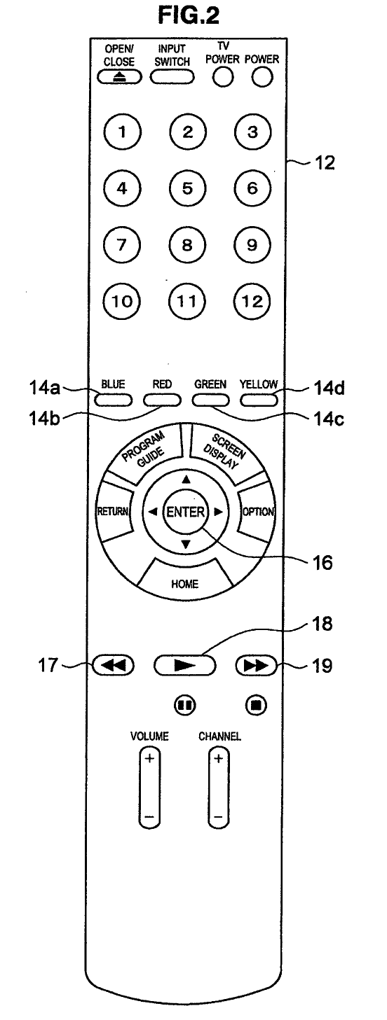

FIG. 2 is an explanatory view illustrating the appearance of a remote control 12 for operating the recording and playback device 10 according to the first embodiment of the present invention. The appearance the remote control 12 for operating the recording and playback device 10 according to the first embodiment of the present invention is described hereinafter with reference to FIG. 2.

The remote control 12 sends out an operation command to the recording and playback device 10 through an infrared ray or a radio wave. Many buttons are placed on the remote control 12, and typical buttons are: a blue button 14a, a red button 14b a green button 14c, a yellow button 14d, an enter button 16, a playback button 18, and skip buttons 17 and 19.

When operating the recording and playback device 10 at a distance, it is possible to cause the recording and playback device 10 to perform program recording reservation, program recording (so-called manual recording), playback of a recorded program or the like by manipulating the buttons placed on the remote control 12. The first embodiment of the present invention is characterized by directly causing the recording and playback device 10 to perform operation by pressing the button placed on the remote control 12 when a variety of information related to the recording and playback device 10 is displayed on the display portion 114 and sending out a command to the recording and playback device 10.

The appearance of the remote control 12 for operating the recording and playback device 10 according to the first embodiment of the present invention is described with reference to FIG. 2 in the foregoing. In the following, the configuration of the recording and playback device 10 according to the first embodiment of the present invention is described.

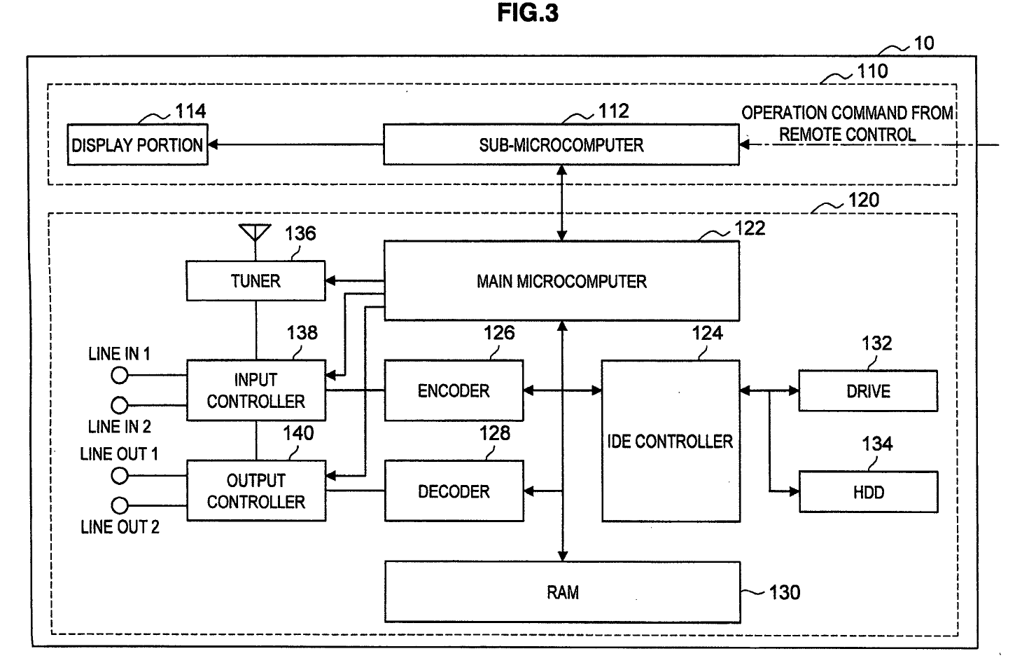

FIG. 3 is an explanatory view illustrating the configuration of the recording and playback device 10 according to the first embodiment of the present invention. The configuration of the recording and playback device 10 according to the first embodiment of the present invention is described hereinafter with reference to FIG. 3.

Referring to FIG. 3, the recording and playback device 10 according to the first embodiment of the present invention includes an unswitched power system 110 and a switched power system 120.

The unswitched power system 110 is a section that is energized even if the recording and playback device 10 is turned off, as long as the recording and playback device 10 is plugged in and energized. The state where only the unswitched power system 110 is energized is called “standby state”. The unswitched power system 110 includes a sub-microcomputer 112 and the display portion 114.

The sub-microcomputer 112 is an example of an information acquisition portion of the present invention. The sub-microcomputer 112 includes a central processing unit (CPU), read only memory (ROM), random access memory (RAM) and so on, for example and exchanges data with a main microcomputer 122, which is described later. Further, the sub-microcomputer 112 determines information to be displayed on the display portion 114 and controls display of information on the display portion 114.

The display portion 114 displays information such as the current time, a playback time and a recordable time of the hard disk or the optical disk, as described earlier. In this embodiment, the display portion 114 further displays a variety of information related to the recording and playback device 10. The information to be displayed on the display portion 114 is determined by the sub-microcomputer 112, and display control is performed by the sub-microcomputer 112.

On the other hand, the switched power system 120 is a section that is not energized if the recording and playback device 10 is turned off, despite that the recording and playback device 10 is plugged in and energized. The state where the switched power system 120 is energized is called “power-on state”. The switched power system 120 includes the main microcomputer 122, an integrated drive electronics (IDE) controller 124, an encoder 126, a decoder 128, random access memory (RAM) 130, the drive 132, a hard disk drive (HDD) 134, a tuner 136, an input controller 138, and an output controller 140.

The main microcomputer 122 is an example of an information collection portion, an execution control portion and a display setting portion of the present invention. The main microcomputer 122 includes CPU, ROM, RAM and so on, for example, and performs numerical calculation, information processing, device control, and so on. The main microcomputer 122 according to this embodiment is connected to each portion inside the recording and playback device 10 and controls the operation of each portion of the recording and playback device 10.

The IDE controller 124 controls reading/writing of data from/to an optical disk loaded in the drive 132 or the HDD 134. The IDE controller 124 controls access to the drive 132 or the HDD 134 so as to record data into either one of the optical disk loaded in the drive 132 or the HDD 134.

The encoder 126 encodes video data and audio data in a prescribed format so as to record the data into the optical disk loaded in the drive 132 or the HDD 134. In this embodiment, the encoder 126 encodes video data and audio data that are supplied from the input controller 138 in a prescribed format. The prescribed format may be H.264 format or the like, for example.

The decoder 128 decodes video data and audio data encoded in a prescribed format. In this embodiment, the decoder 128 decodes video data and audio data that are encoded in a prescribed format and recorded in the optical disk loaded in the drive 132 or the HDD 134. The video data and audio data decoded in the decoder 128 are supplied to the output controller 140.

The RAM 130 stores data that basically varies during processing in programs and operation parameters to be used by the main microcomputer 122 when performing numerical calculation, information processing, device control, and so on.

The drive 132 is a portion into which an optical disk for recording video data and audio data is loaded. An optical disk that can be loaded into the drive 132 may be a recordable or rewritable optical disk having a capacity of several hundreds of megabytes to several tens of gigabytes, such as a DVD and a Blu-ray disk. By loading an optical disk into the drive 132, broadcast data received by the tuner 136 or video data and audio data input through a line can be recorded into the optical disk.

The HDD 134 includes a hard disk for recording video data and audio data. Broadcast data received by the tuner 136 or video data and audio data input through a line can be recorded into the HDD 134.

The tuner 136 acquires a video signal and an audio signal from analog broadcast data or digital broadcast data that is received by the recording and playback device 10. The video signal and the audio signal that are acquired by the tuner 136 are recorded into the optical disk loaded in the drive 132 or the HDD 134, so that the recording and playback device 10 can record a television program.

The input controller 138 controls input of video data and audio data from either one of the tuners 136 or two line input terminals (LINE IN 1 and LINE IN 2). The main microcomputer 122 determines from which of the tuner 136 or the two line input terminals the video data and audio data are to be input. The video data and audio data that are input from an input source controlled by the input controller 138 are supplied to the encoder 126 and encoded in a prescribed format (e.g. H.264 format).

The output controller 140 controls output of video data and audio data decoded by the decoder 128 to each of two line output terminals (LINE OUT 1 and LINE OUT 2). The main microcomputer 122 determines to which of the two line output terminals the decoded video data and audio data are to be output.

The configuration of the recording and playback device 10 according to the first embodiment of the present invention is described in the foregoing. In the following, the operation of the recording and playback device 10 according to the first embodiment of the present invention is described.

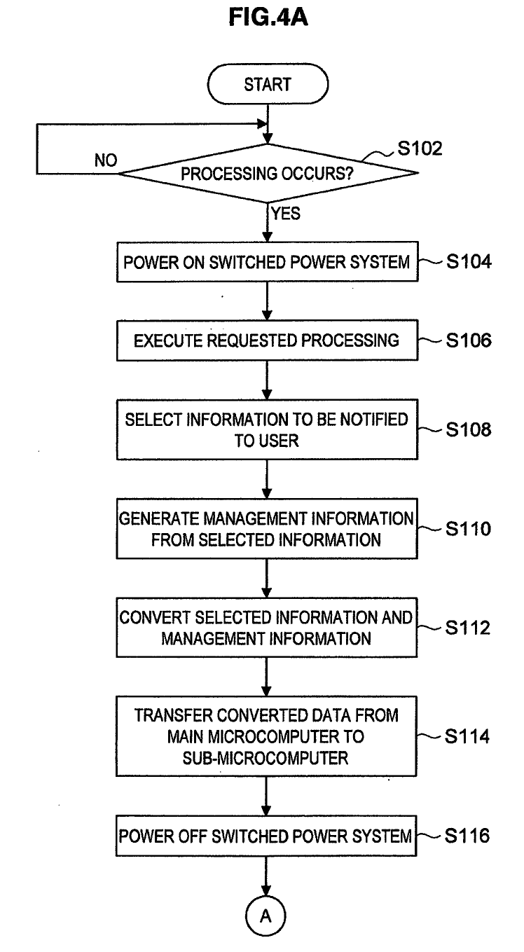

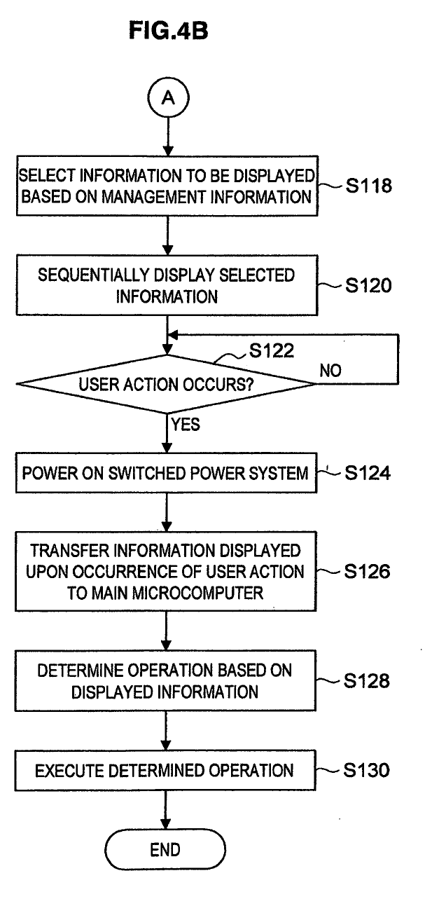

FIGS. 4A and 4B are flowcharts illustrating the operation of the recording and playback device 10 according to the first embodiment of the present invention. The operation of the recording and playback device 10 according to the first embodiment of the present invention is described hereinafter with reference to FIGS. 4A and 4B.

Firstly, in the state where the main power is off, which is the state where the switched power system 120 is not energized, the recording and playback device 10 waits until some processing occurs (step S102). Some processing in this step indicates processing that causes energization of the switched power system 120, such as turn-on of the main power of the recording and playback device 10 by a user of the recording and playback device 10, start of reserved recording preset by a user, acquisition of EPG and so on.

If it is determined in the step S102 that processing that causes energization of the switched power system 120 is started, the switched power system 120 is energized and the power is turned on (step S104). Then, the processing requested to the recording and playback device 10 that occurs in the step S102 is executed (step S106).

For example, if the main power of the recording and playback device 10 is turned on, each portion of the switched power system 120 is energized, so that the recording and playback device 10 is enabled. For another example, if it reaches a start time of reserved recording that is preset by a user, a program in the channel specified by the user is recorded into a specified medium (the optical disk loaded in the drive 132 or the HDD 134) up to the specified time. For yet another example, if it reaches a time to acquire EPG, digital broadcast data or analog broadcast data is received by the tuner 136, and EPG information contained in the received broadcast wave is expanded in the HDD 134 or the like.

While the processing requested to the recording and playback device 10 is executed, the main microcomputer 122 selects information to be notified to a user of the recording and playback device 10 (step S108). Examples of information to be notified to a user are: the total number of new recorded programs, the total playback time of new recorded programs, new recorded program information, a remaining recording time, an expected time when a recorded program will be overwritten due to insufficient remaining space, the total number of unviewed recorded programs, the total playback time of unviewed recorded programs, unviewed recorded program information, the total number of all recorded programs, the total playback time of all recorded programs, program information of a program that is likely to be reserved for recording by a user, advertisement information to be provided to a user, setting information of the recording and playback device 10, and so on.

The total number of new recorded programs indicates the total number of the programs newly recorded by reserved recording of the recording and playback device 10. Likewise, the total playback time of new recorded programs indicates the total playback time of the programs newly recorded by reserved recording of the recording and playback device 10. The new recorded program information indicates information of a program newly recorded by reserved recording of the recording and playback device 10. The program information is acquired from EPG information that is expanded in the internal memory of the main microcomputer 122.

After the information to be notified to a user of the recording and playback device 10 is selected by the main microcomputer 122, management information is generated from the information selected by the main microcomputer 122 (step S110). The generated management information is stored, together with the selected information, into the internal memory of the main microcomputer 122. In this embodiment, the management information is the management number of the information to be notified to a user, the frequency of displaying the information to be notified to a user on the display portion 114, the order of displaying the information to be notified to a user on the display portion 114, and so on, for example. The management number indicates the order of transferring the selected information from the main microcomputer 122 to the sub-microcomputer 112.

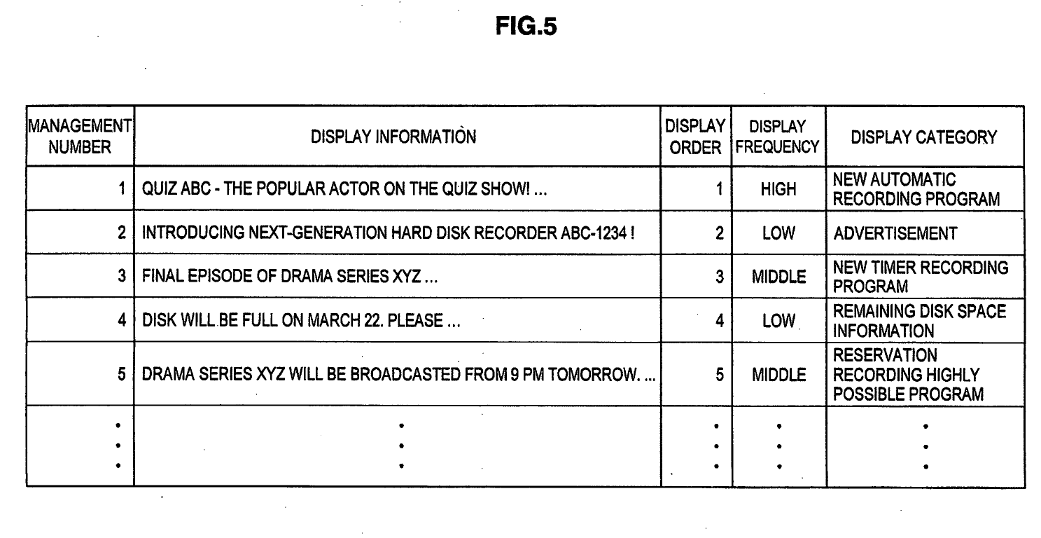

FIG. 5 is an explanatory view showing an example of the relationship between the information selected by the main microcomputer 122 and the management information in a table. As shown in FIG. 5, the information selected by the main microcomputer 122 and the management information are stored in the internal memory of the main microcomputer 122 in association with each other.

In the table shown in FIG. 5, the “display information” indicates the content of messages to be displayed on the display portion 114, the “display order” indicates the order of displaying messages on the display portion 114, and the “display frequency” indicates the frequency of displaying messages on the display portion 114. The display frequency and the display order may be set according to the preference of a user, and, in this case, a display setting portion for setting the “display order” and the “display frequency” may be placed inside the main microcomputer 122, and the display setting portion may reflect the display frequency and the display order that are set by a user. Further, the display setting portion may allow setting of whether or not to display information. The display setting portion may enable the setting of both or either one of the frequency to display information and whether to display information.

The information recorded in the main microcomputer 122 is transferred from the main microcomputer 122 to the sub-microcomputer 112 later. The timing to transfer the information may be any time during the period of transition of the power state of the recording and playback device 10 from the power-on state to the standby state. For example, the information may be transferred from the main microcomputer 122 to the sub-microcomputer 112 while the power state of the recording and playback device 10 changes from the power-on state to the standby state after the execution of the processing requested by a user is completed, as described later.

After the management information is generated, the information selected by the main microcomputer 122 and the management information are converted into a format suitable for the sub-microcomputer 112 to display the information on the display portion 114 (step S112). The sub-microcomputer 112 for driving the display portion 114 is often low power consumption, low cost microcomputer, and therefore it may not have Japanese Kanji ROM or the operation speed may be slower than that of the main microcomputer. For this reason, the information is converted into a format that is suitable for the sub-microcomputer 112 to display the information on the display portion 114 in advance in the main microcomputer 122, thereby suppressing a decrease in processing speed when displaying the information on the display portion 114 by the sub-microcomputer 112 and an increase in cost due to the install of Japanese Kanji ROM.

After the information is converted, the converted information is transferred from the main microcomputer 122 to the sub-microcomputer 112 (step S114). The sub-microcomputer 112 stores the transferred information into the internal memory. Then, after the execution of the processing that is started in the step S106 is completed, the energization of the switched power system 120 is stopped to turn off power supply to the switched power system 120 (step S116). By turning off power supply to the switched power system 120, the recording and playback device 10 enters the sleep state.

While power supply to the switched power system 120 is off and the recording and playback device 10 is in the sleep state, the sub-microcomputer 112 selects information to be displayed on the display portion 114 from the information selected by the main microcomputer 122 based on the management information transmitted from the main microcomputer 122 (step S118). Then, the information selected in the step S118 is sequentially displayed on the display portion 114 (step S120). If, viewing the information displayed on the display portion 114, a user of the recording and playback device 10 manipulates the remote control 12 or the main body of the recording and playback device 10, the recording and playback device 10 starts power supply to the switched power system 120 and performs the operation corresponding to the information displayed on the display portion 114 at the time of the user manipulation.

The recording and playback device 10 waits until an action by a user occurs (step S122), and upon occurrence of the user action, the recording and playback device 10 starts power supply to the switched power system 120 and turns on the power of the switched power system 120 (step S124). Then, the information, which is displayed on the display portion 114 at the time when the action by the user occurs in the step S122, is transferred from the sub-microcomputer 112 to the main microcomputer 122 (step S126). The information transferred from the sub-microcomputer 112 to the main microcomputer 122 in this step may be the management number corresponding to the information displayed on the display portion 114 instead of the information itself displayed on the display portion 114.

The main microcomputer 122 determines the operation of the recording and playback device 10 based on the information transferred from the sub-microcomputer 112 (step S128) and executes the determined operation (step S130). An example of the relationship between the information displayed on the display portion 114 and the operation based on the information according to the first embodiment of the present invention is described hereinafter. The following example is merely an example of the operation, and the present invention is not limited to the example.

In the case where the total number of new recorded programs or the total playback time of new recorded programs is displayed on the display portion 114, if the enter button 16 of the remote control 12 is pressed, for example, the processing of displaying a screen indicating a list of the programs that are newly recorded by reserved recording of the recording and playback device 10 on a television or the like connected to the recording and playback device 10 is executed.

In the case where the new recorded program information is displayed on the display portion 114, if the enter button 16 or the playback button 18 of the remote control 12 is pressed, for example, the processing of starting playback of the program or the processing of displaying program information of the program on a television or the like connected to the recording and playback device 10 is executed.

In the case where the remaining recording time or the information about an expected time when a recorded program will be overwritten due to insufficient remaining space is displayed on the display portion 114, if the enter button 16 of the remote control 12 is pressed, for example, the processing of displaying a screen for erasing the oldest recorded program on a television or the like connected to the recording and playback device 10 or the processing of displaying a screen where the recorded program are listed in chronological order on a television or the like connected to the recording and playback device 10 is executed.

In the case where the total number of unviewed recorded programs or the total playback time of unviewed recorded programs is displayed on the display portion 114, if the enter button 16 of the remote control 12 is pressed, for example, the processing of displaying a list screen of unviewed recorded programs on a television or the like connected to the recording and playback device 10 is executed.

In the case where the total number of all recorded programs or the total playback time of all recorded programs is displayed on the display portion 114, if the enter button 16 of the remote control 12 is pressed, for example, the processing of displaying a screen where the recorded program are listed in reverse chronological order on a television or the like connected to the recording and playback device 10 is executed.

In the case where the program information of a program that is likely to be reserved for recording by a user is displayed on the display portion 114, if the enter button 16 of the remote control 12 is pressed, for example, the processing of displaying a recording reservation screen of the program on a television or the like connected to the recording and playback device 10 is executed.

In the case where the advertisement information to be provided to a user is displayed on the display portion 114, if the enter button 16 of the remote control 12 is pressed, for example, the processing of displaying the advertisement on a television or the like connected to the recording and playback device 10 is executed.

In the case where the setting information of the recording and playback device 10 is displayed on the display portion 114, if the enter button 16 of the remote control 12 is pressed, for example, the processing of displaying a setting change screen of the setting on a television or the like connected to the recording and playback device 10 is executed.

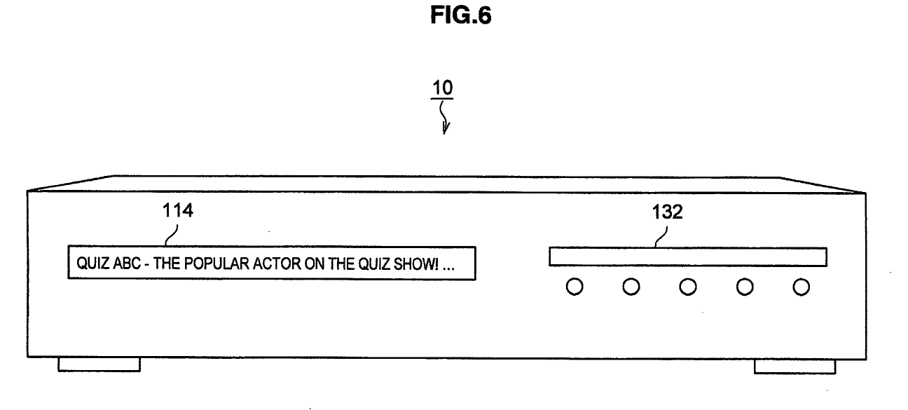

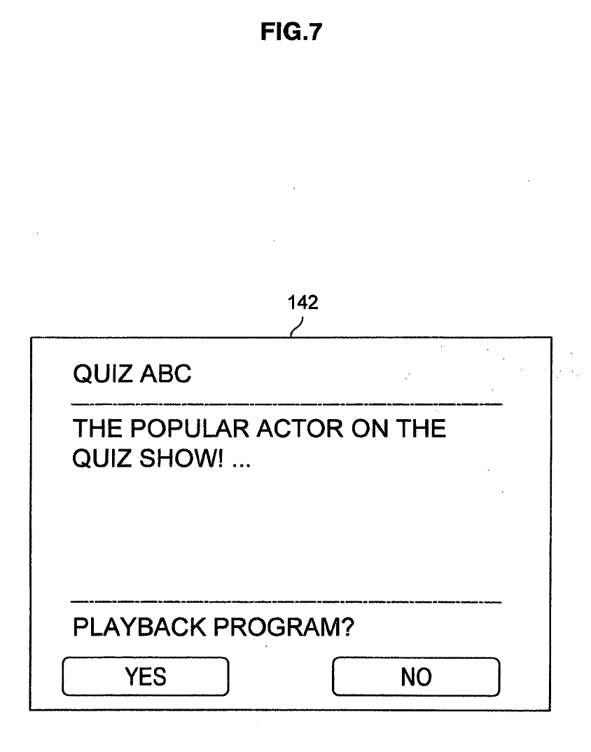

FIG. 6 is an explanatory view illustrating the case where program information of a program that is likely to be played back by a user is displayed on a display portion 114. FIG. 7 is an explanatory view illustrating an example of a screen displayed on a television or the like connected to the recording and playback device 10 when a user presses the enter button 16 of the remote control 12 in the case where the information as shown in FIG. 6 is displayed on the display portion 114.

FIG. 7 is an explanatory view showing a playback confirmation window 142 to playback a recorded program, which is displayed on the display portion 114. The recording and playback device 10 according to this embodiment may have a function to automatically record a program that is likely to be viewed by a user. The program that is automatically recorded in the recording and playback device 10 is accumulated inside the recording and playback device 10 (e.g. in the HDD 134). The function of automatically recording a program into a recording and playback device based on the preference of a user is a known technique and thus not described in detail.

Hitherto, when a user plays back a program, including an automatically recorded program, in a recording and playback device, it is necessary to turn on the power of the recording and playback device, open a list screen of recorded programs from a menu or the like to view what programs are recorded, and further select a program to be played back from the list screen. On the other hand, in the first embodiment of the present invention, in the case where program information of a program that is likely to be viewed by a user and automatically recorded in the recording and playback device 10 based on the preference of the user is displayed on the display portion 114, the playback confirmation window 142 for confirming whether to play back the recorded program as shown in FIG. 7, instead of a list screen of recorded programs, may be displayed on a television or the like connected to the recording and playback device 10 when the user presses the enter button 16 of the remote control 12, for example. When starting playback of the program, the user who views the playback confirmation window 142 displayed on the display selects “YES” by the enter button 16, thereby playing back and displaying the program automatically recorded in the recording and playback device 10 on a television or the like connected to the recording and playback device 10. In the case where program information of a program that is automatically recorded in the recording and playback device 10 based on the preference of the user is displayed on the display portion 114, if the user presses the playback button 18 of the remote control 12, for example, the program may be directly played back and displayed on a television or the like connected to the recording and playback device 10.

As described above, if a user presses the enter button 16 of the remote control 12 when program information of a program that is likely to be viewed by a user and automatically recorded in the recording and playback device 10 is displayed on the display portion 114, a screen that prompts the user to play back the content such as the playback confirmation window 142 is displayed on a television or the like connected to the recording and playback device 10, thereby simplifying the user operation and improving the user-friendliness. In addition to program information of a program that is automatically recorded in the recording and playback device 10, program information of a program that is manually reserved for recording by a user may be displayed on the display portion 114, and the same processing as above may be performed.

By pressing the button other than the enter button 16, the following operation may be implemented.

For example, by pressing the blue button 14a of the remote control 12, the processing of displaying the information displayed on the display portion 114 again from the top may be performed.

For another example, by pressing the red button 14b of the remote control 12, the processing of turning on the power of the recording and playback device 10 (i.e. energizing the switched power system 120) and playing back a recorded program corresponding to the information displayed on the display portion 114 may be performed.

For yet another example, by pressing the green button 14c of the remote control 12, the processing of turning on the power of the recording and playback device 10 (i.e. energizing the switched power system 120) and displaying the detail of the information displayed on the display portion 114 on a television or the like connected to the recording and playback device 10 may be performed.

For still another example, by pressing the yellow button 14d or the skip buttons 17 and 19 of the remote control 12, the processing of skipping the information displayed on the display portion 114 and displaying the next information may be performed.

The operation of the recording and playback device 10 according to the first embodiment of the present invention is described in the foregoing with reference to FIGS. 4A and 4B. The series of operations described above may be executed by sequentially reading the computer program stored inside the recording and playback device 10, such as inside the main microcomputer 122 or the sub-microcomputer 112.

As described in the foregoing, according to the first embodiment of the present invention, it is possible to notify information to a user of the recording and playback device 10 by displaying the information on the display portion 114 before the user turns on the power of the recording and playback device 10 or performs operation for retrieving program information. Because the switched power system 120 is not energized when the information is displayed on the display portion 114, it is possible to reduce power consumption of the recording and playback device 10. Further, it is possible to directly execute the processing desired by a user without manipulating a complicated menu screen or the like simply by the user viewing the content displayed on the display portion 114 and pressing the enter button 16 or the like of the remote control 12.

### Second Embodiment

In the first embodiment of the present invention, the information collected by the main microcomputer 122 is transferred to the sub-microcomputer 112, and the information is displayed on the display portion 114 by the sub-microcomputer 112. In the second embodiment of the present invention, on the other hand, a recording and playback device that transfers the information collected by the main microcomputer 122 to another device such as a mobile terminal, so that the information is displayed on the mobile terminal and an operation is made from the mobile terminal is described.

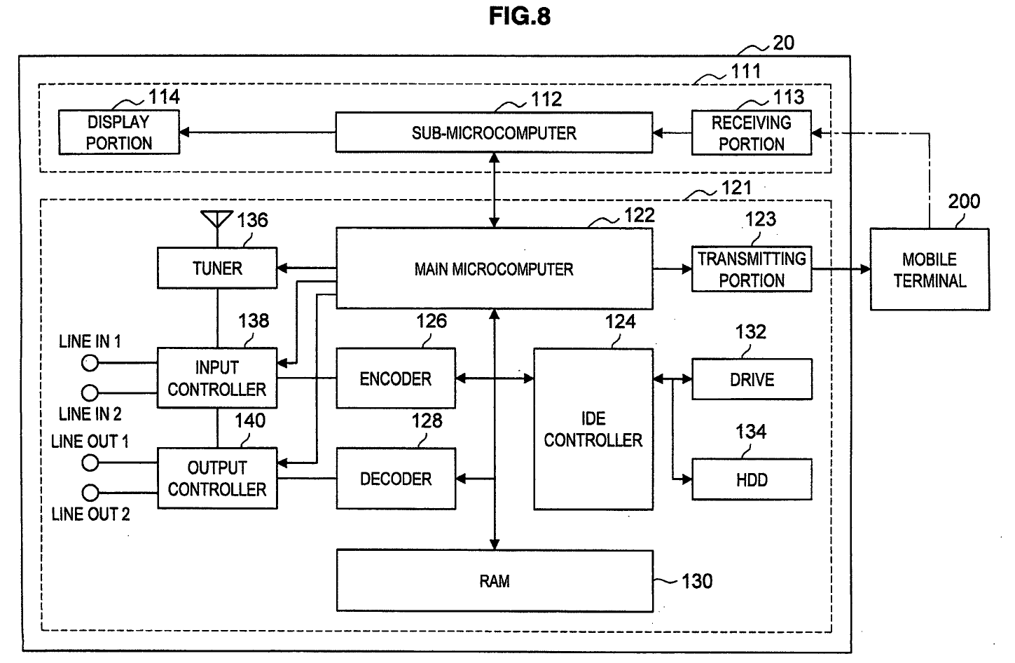

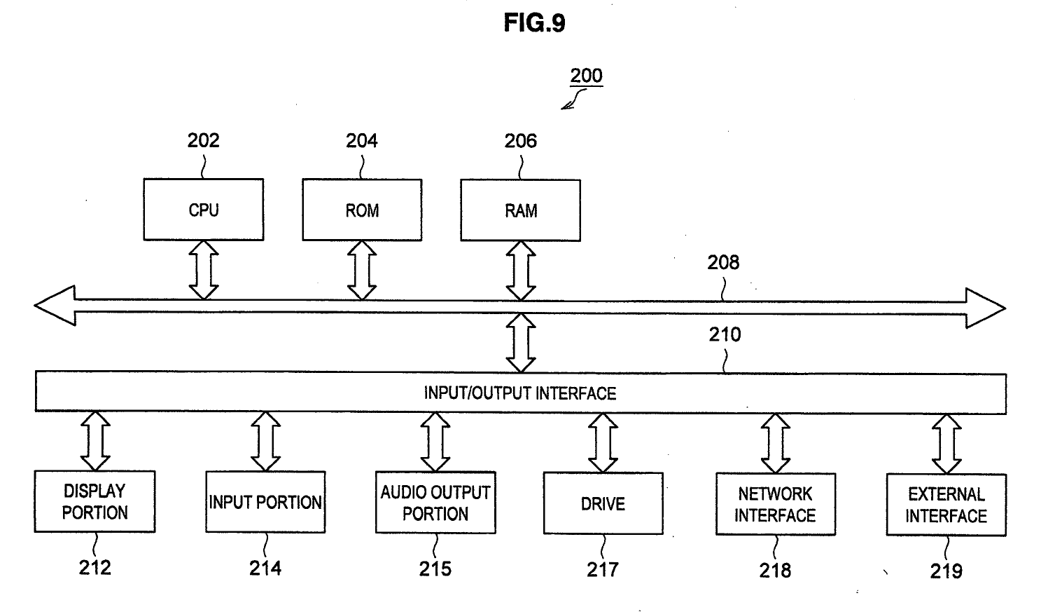

FIG. 8 is an explanatory view illustrating a recording and playback device 20 and a mobile terminal 200 according to the second embodiment of the present invention. FIG. 9 is an explanatory view illustrating the hardware configuration of the mobile terminal 200 according to the second embodiment of the present invention. The recording and playback device 20 and the mobile terminal 200 according to the second embodiment of the present invention are described hereinafter with reference to FIGS. 8 and 9.

In the recording and playback device 20 according to the second embodiment of the present invention shown in FIG. 8, a receiving portion 113 is added to an unswitched power system 111, and a transmitting portion 123 is added to a switched power system 121 compared with the recording and playback device 10 according to the first embodiment of the present invention shown in FIG. 3. The recording and playback device 20, like the recording and playback device 10, has the standby state and the power-on state as the energization state. The main microcomputer 122 according to the second embodiment of the present invention is an example of the information collection portion, the execution control portion and the display setting portion of the present invention.

The transmitting portion 123 transmits the information selected by the main microcomputer 122 to be notified to a user of the recording and playback device 20 and the management information generated from the information selected by the main microcomputer 122 to the mobile terminal 200 by radio.

The receiving portion 113 receives an operation command to the recording and playback device 20, which is transmitted from the mobile terminal 200 by radio. The operation command received by the receiving portion 113 is supplied to the sub-microcomputer 112 and transferred from the sub-microcomputer 112 to the main microcomputer 122. As a result, the switched power system 121 is energized, and the operation according to the operation command to the recording and playback device 20 that is directed from the mobile terminal 200 is started in the recording and playback device 20.

The mobile terminal 200 is a terminal that is mainly carried along for use, and it preferably includes a radio communication interface. The mobile terminal 200 may be a cellular phone or a portable game machine, for example.

Referring to FIG. 9, the mobile terminal 200 according to one embodiment of the present invention includes a CPU 202, ROM 204, RAM 206, an internal bus 208, an input/output interface 210, a display portion 212, an input portion 214, an audio output portion 215, a drive 217, a network interface 218 and an external interface 219.

The CPU 202 performs numerical calculation, information processing, device control, and so on. The CPU 202 performs numerical calculation, information processing and device control by sequentially reading a program stored in the ROM 204 or data stored in the RAM 206, or based on a signal corresponding to a command input via the input portion 214 by a user of the mobile terminal 200, for example, or a signal transmitted via the network interface 218 from the recording and playback device 20.

The ROM 204 stores fixed data that is basically not altered in programs and operation parameters to be used by the CPU 202 when performing numerical calculation, information processing, device control, and so on. The RAM 206 stores data that basically varies during processing in programs and operation parameters to be used by the CPU 202 when performing numerical calculation, information processing, device control, and so on.

The internal bus 208 is a path for data exchange inside the mobile terminal 200. The CPU 202, the ROM 204 and the RAM 206 are connected to each other through the internal bus 208. The internal bus 208 is also connected to the input/output interface 210 and supplies a signal corresponding to a command input via the input portion 214 and a signal transmitted via the network interface 218 from the recording and playback device 20 that are sent through the input/output interface 210 to the CPU 202.

The input/output interface 210 mediates input and output of information. The input/output interface 210 is connected to the display portion 212, the input portion 214, the audio output portion 215, the drive 217, the network interface 218 and the external interface 219. The input/output interface 210 is also connected to the internal bus 208 as described above and supplies a signal corresponding to a command input via the input portion 214 and a signal transmitted via the network interface 218 from the recording and playback device 20 to the CPU 202 through the internal bus 208.

The display portion 212 displays information about an input from the input portion 214, a result of performing numerical calculation, information processing, device control or the like in the CPU 202 and so on. The display portion 212 may be a liquid crystal display device, an organic EL display device or the like, for example.

The input portion 214 is operated by a user of the mobile terminal 200, for example, when inputting various kinds of commands to the CPU 202. The input portion 214 may be a button, a keyboard, a touch pad or the like, for example.

The audio output portion 215 outputs a sound that is generated when the mobile terminal 200 executes processing that accompanies the output of a sound. A portable recording medium is inserted into the drive 217, and data is exchanged between the inserted recording medium and the mobile terminal 200. A portable recording medium may be a magnetic disk, an optical disk, a magneto-optical disk, a semiconductor memory or the like, and the drive 217 may be a device capable of reading such a recording medium.

The network interface 218 exchanges information with the recording and playback device 20 or the like by radio. The external interface 219 mediates exchange of information with a peripheral device that is connected to the mobile terminal 200. The external interface 219 may be a universal serial bus (USB) port or the like, for example.

Although the mobile terminal 200 shown in FIG. 9 does not include a hard disk drive (HDD), the configuration of the mobile terminal 200 shown in FIG. 9 is merely an example of the present invention, and a mobile terminal that includes a hard disk drive may be used in the present invention.

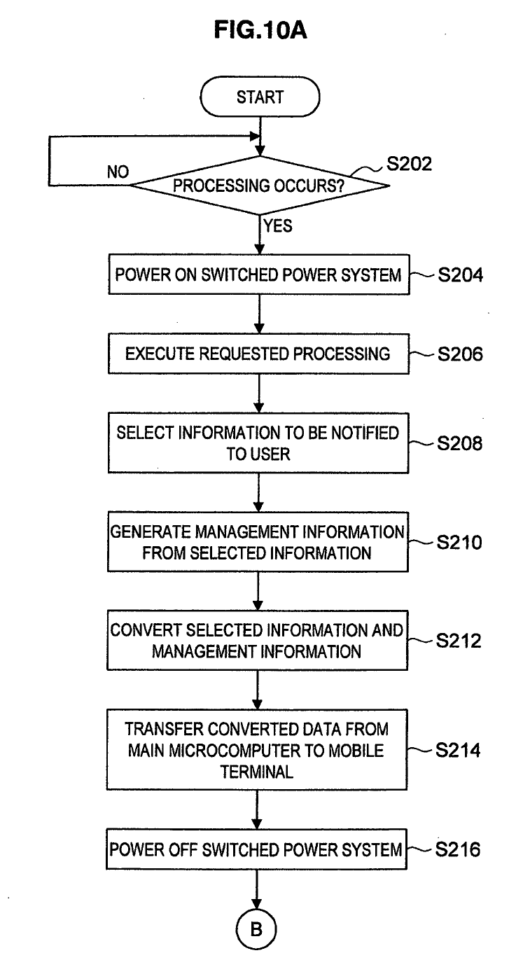

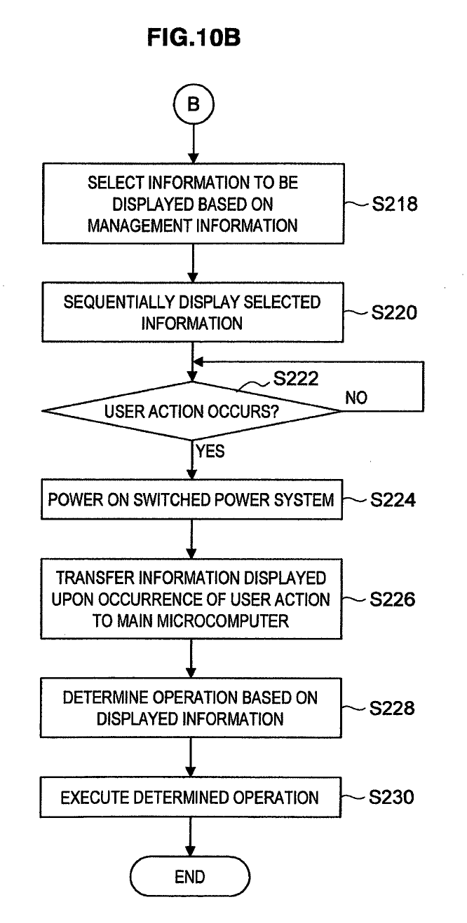

The recording and playback device 20 and the mobile terminal 200 according to the second embodiment of the present invention are described with reference to FIGS. 8 and 9 in the foregoing. In the following, the operation of the recording and playback device 20 and the mobile terminal 200 according to the second embodiment of the present invention are described with reference to FIGS. 10A and 10B.

FIGS. 10A and 10B are flowcharts illustrating the operation of the recording and playback device 20 and the mobile terminal 200 according to the second embodiment of the present invention. The operation of the recording and playback device 20 and the mobile terminal 200 according to the second embodiment of the present invention are described hereinafter with reference to FIGS. 10A and 10B.

The operation from waiting for the occurrence of some processing in the recording and playback device 20 to conversion of the information selected by the main microcomputer 122 and the management information is the same as the operation of the recording and playback device 10 according to the first embodiment of the present invention shown in FIG. 4A (step S202, step S204, step S206, step S208, step S210 and step S212).

After conversion of the information selected by the main microcomputer 122 and the management information in the step S212 is completed, the converted information is transmitted from the main microcomputer 122 to the mobile terminal 200 via the transmitting portion 123 (step S214). The mobile terminal 200 stores the transmitted information into the ROM 204 or the RAM 206. Then, after the execution of the processing that is started in the step S206 is completed, the energization of the switched power system 121 is stopped to turn off power supply to the switched power system 121 (step S216).

In this embodiment also, the transfer frequency and the transfer order of the information may be set according to the preference of a user, and, in this case, a transfer setting portion for setting the “transfer order” and the “transfer frequency” may be placed inside the main microcomputer 122, and the transfer setting portion may reflect the transfer frequency and the transfer order of the information that are set by a user. Further, the transfer setting portion may allow setting of whether or not to transfer the information. The transfer setting portion may enable the setting of both or either one of the frequency to transfer information and whether to transfer information.

While power supply to the switched power system 121 is off and the recording and playback device 20 is in the sleep state, the mobile terminal 200 selects information to be displayed on the display portion 212 from the information selected by the main microcomputer 122 based on the management information transmitted from the main microcomputer 122 (step S218). Then, the information selected in the step S218 is sequentially displayed on the display portion 212 (step S220). If, viewing the information displayed on the display portion 212, a user of the recording and playback device 20 manipulates the mobile terminal 200, the recording and playback device 20 starts power supply to the switched power system 121 and performs the operation corresponding to the information that is displayed on the display portion 212 at the time of the user manipulation.

The recording and playback device 20 waits until an action by a user of the mobile terminal 200 occurs (step S222), and upon occurrence of the action by the user of the mobile terminal 200, the recording and playback device 20 starts power supply to the switched power system 121 and turns on the power of the switched power system 121 (step S224). Then, the information that is displayed on the display portion 212 at the time when the action by the user occurs in the step S222 is transmitted from the mobile terminal 200 to the recording and playback device 20 (step S226). The information transferred from the mobile terminal 200 to the recording and playback device 20 in this step may be the management number corresponding to the information displayed on the display portion 212 instead of the information itself displayed on the display portion 212.

The recording and playback device 20 receives the information transmitted from the mobile terminal 200 by the receiving portion 113. The received information is supplied from the receiving portion 113 to the sub-microcomputer 112 and then transferred from the sub-microcomputer 112 to the main microcomputer 122. The main microcomputer 122 determines the operation of the recording and playback device 20 based on the transferred information (step S228) and executes the determined operation (step S230).

The relationship between the information displayed on the display portion 212 and the operation of the recording and playback device 20 based on the information may be the same as that in the first embodiment of the present invention which is described earlier. Just like in the first embodiment of the present invention described above, the example shown in the second embodiment of the present invention is merely an example of the operation of the recording and playback device 20, and the present invention is not limited to the example.

The operation of the recording and playback device 20 and the mobile terminal 200 according to the second embodiment of the present invention are described with reference to FIGS. 10A and 10B in the foregoing. The series of operations described above may be executed by sequentially reading the computer program stored inside the recording and playback device 20, such as inside the main microcomputer 122 or the sub-microcomputer 112.

As described in the foregoing, according to the second embodiment of the present invention, it is possible to notify information to a user of the recording and playback device 20 by displaying the information on the display portion 212 of the mobile terminal 200 before the user turns on the power of the recording and playback device 20 or performs operation for retrieving program information. Because the switched power system 121 is not energized when the information is displayed on the display portion 212, it is possible to reduce power consumption of the recording and playback device 20. Further, it is possible to directly execute the processing desired by a user without manipulating a complicated menu screen or the like simply by the user viewing the content displayed on the display portion 212 and manipulating the input portion 214 of the mobile terminal 200.

It should be understood by those skilled in the art that various modifications, combinations, sub-combinations and alterations may occur depending on design requirements and other factors insofar as they are within the scope of the appended claims or the equivalents thereof.

What is claimed is:

1. An information accumulation apparatus that accumulates contents and has a power-on state and a standby state as a power state, comprising:
an information collection portion to collect information including content information related to a content and internal information related to the information accumulation apparatus during the power-on state;
an information acquisition portion to acquire the information collected by the information collection portion during transition from the power-on state to the standby state; and
a display portion to sequentially display the information acquired by the information acquisition portion during the standby state.

2. The information accumulation apparatus according to claim 1, further comprising:
an execution control portion to control execution of processing based on the information displayed on the display portion according to an operation command from a user by shifting the power state to the power-on state.

3. The information accumulation apparatus according to claim 2, wherein
the information collection portion collects content information of an accumulated content,
the display portion displays the content information of the accumulated content, and
the execution control portion controls execution of processing to prompt playback of the accumulated content according to an operation command from a user.

4. The information accumulation apparatus according to claim 1, further comprising:
a display setting portion to set a frequency to display and/or whether to display the information collected by the information collection portion on the display portion, wherein
the information acquisition portion acquires the information collected by the information collection portion based on setting of the display setting portion.

5. The information accumulation apparatus according to claim 4, wherein
the display setting portion sets a priority order of the information to be displayed on the display portion.

6. The information accumulation apparatus according to claim 1, wherein
the information collection portion collects advertisement information.

7. An information accumulation apparatus that accumulates contents and has a power-on state and a standby state as a power state, comprising:
an information collection portion to collect information including content information related to a content and internal information related to the information accumulation apparatus during the power-on state; and
an information transfer portion to transfer the information collected by the information collection portion to another device connected over a network so as to display the information on the other device during transition from the power-on state to the standby state.

8. The information accumulation apparatus according to claim 7, further comprising:
an execution control portion to control execution of processing based on the information transferred to the other device and displayed on the other device according to an operation command from a user by shifting the power state to the power-on state.

9. The information accumulation apparatus according to claim 8, wherein
the information collection portion collects content information of an accumulated content,
the display portion displays the content information of the accumulated content, and
the execution control portion controls execution of processing to prompt playback of the accumulated content according to an operation command from a user.

10. The information accumulation apparatus according to claim 7, further comprising:
a transfer setting portion to set a frequency to transfer and/or whether to transfer the information collected by the information collection portion to the other device, wherein
the information transfer portion transfers the information collected by the information collection portion based on setting of the transfer setting portion.

11. The information accumulation apparatus according to claim 10, wherein
the transfer setting portion sets a priority order of the information to be displayed on the other device.

12. The information accumulation apparatus according to claim 7, wherein
the information collection portion collects advertisement information.

13. An information display method for displaying information on an electronic device that accumulates contents and has a power-on state and a standby state as a power state, comprising the steps of:
collecting information including content information related to a content and internal information related to the electronic device during the power-on state;
acquiring the information collected in the collecting step during transition from the power-on state to the standby state; and
sequentially displaying the information acquired in the acquiring step during the standby state.

14. An information display method for displaying information on an electronic device that accumulates contents and has a power-on state and a standby state as a power state, comprising the steps of:
collecting information including content information related to a content and internal information related to the electronic device during the power-on state; and
transferring the information collected in the collecting step to another device connected over a network so as to display the information on the other device during transition from the power-on state to the standby state.

15. A computer program for displaying information on a computer that accumulates contents and has a power-on state and a standby state as a power state, causing the computer to execute a process comprising the steps of:
collecting information including content information related to a content and internal information related to the computer during the power-on state;
acquiring the information collected in the collecting step during transition from the power-on state to the standby state; and
sequentially displaying the information acquired in the acquiring step during the standby state.

16. A computer program for displaying information on a computer that accumulates contents and has a power-on state and a standby state as a power state, causing the computer to execute a process comprising the steps of:
collecting information including content information related to a content and internal information related to the computer during the power-on state; and
transferring the information collected in the collecting step to another device connected over a network so as to display the information on the other device during transition from the power-on state to the standby state.
